(19) United States
(12) Patent Application Publication
(10) Pub. No.: US 2023/0194897 A1
(43) Pub. Date: Jun. 22, 2023

(54) Electroactive Lenses with Cylinder Rotational Control

(71) Applicant: e-Vision Smart Optics, Inc., Sarasota, FL (US)

(72) Inventor: Anthony Van Heugten, Sarasota, FL (US)

(73) Assignee: e-Vision Smart Optics, Inc., Sarasota, FL (US)

(21) Appl. No.: 18/171,935

(22) Filed: Feb. 21, 2023

Related U.S. Application Data
(63) Continuation of application No. PCT/US2021/047647, filed on Aug. 26, 2021.
(60) Provisional application No. 63/070,858, filed on Aug. 27, 2020.

(51) Int. Cl. G02C 7/08; G02C 7/02; G02F 1/1343

(52) U.S. Cl. CPC G02C 7/083; G02C 7/022; G02F 1/134363

(57) ABSTRACT

An electro-active lens with stacked, rotated cylindrical electro-active lens elements can provide cylinder power along more axes than there are cylindrical electro-active lens elements. For instance, six stacked cylindrical electro-active lens elements, each aligned with a different lens meridian, can produce cylinder power along fifteen unique meridians when actuated up to three at a time. If these fifteen meridians are spaced at 12° increments, then the lens stack can provide cylinder power that is aligned well to correct astigmatism along any axis. Each cylindrical electro-active lens element in the stack can include a liquid crystal layer that is actuated by linear electrodes that are parallel to each other and orthogonal to both the cylindrical electro-active lens element's cylinder axis and optical axis. The electro-active lens can also include a spherical lens element that provides spherical power in addition to any net spherical power produced by the stacked cylindrical electro-active lens elements.

### CROSS-REFERENCE TO RELATED APPLICATIONS

This application is a bypass continuation of International Application No. PCT/US2021/047647, filed on Aug. 26, 2021, which claims the priority benefit, under 35 U. S.C. 119(e), of U.S. Application No. 63/070,858, filed on Aug. 27, 2020. Each of these applications is incorporated herein by reference in its entirety for all purposes.

### BACKGROUND

A patient's prescription for corrective lenses is typically measured by a healthcare practitioner, who records and reports prescription in terms of sphere (SPH), cylinder (CYL), and axis. Sphere indicates the amount of lens power, typically measured in diopters (D), prescribed to correct nearsightedness or farsightedness. Cylinder indicates the amount of lens power needed to correct for astigmatism, which occurs when either the front surface of the eye (cornea) or the lens is egg-shaped instead of spherical. Astigmatism can cause blurred vision at all distances. Axis describes the lens meridian that contains no cylinder power to correct astigmatism. In other words, the axis refers to the rotational orientation of the cylinder error. Although sphere may change quickly over time, cylinder and axis rarely change or change very slowly (e.g., over years), sometimes never over a patient's entire life. A lens that provides both spherical and cylinder correction is called a compound or toric lens.

FIGS. 1A-1E illustrate how the optical cross, or power cross, can be used to show the prescription for a lens with cylinder power. The optical cross is a graphical device useful in illustrating the cylinder powers of the front and back surfaces of a lens. It shows the cylinder powers along the meridians of the lens's surface. (The meridians are orthogonal to the lens's optical axis; the major or principal meridians are the meridians of greatest and least power.) For a spherical lens, these powers are the same for every meridian. A cylindrical lens has optical power that is zero along one meridian, which is aligned with the cylindrical lens's longitudinal axis or axis of power. And a compound or toric lens has optical powers that vary as a function of the meridian angle.

FIG. 1A shows the optical cross for a cylinder lens 100a with a plano rear surface and a convex front surface. This cylinder lens 100a provides +4.00 diopters (D) of optical power along the 180° meridian (equivalent to the 0° meridian) and no optical power along the 90° meridian (equivalent to the 270° meridian). Similarly, FIG. 1B shows the optical cross for a cylinder lens 100b with a plano rear surface and a convex front surface that is rotated by 90° with respect to the cylinder lens 100a in FIG. 1A. This rotation rotates the optical cross by 90°: in FIG. 1B, the optical cross shows +4.00 diopters (D) of optical power along the 90° meridian and no optical power along the 180° meridian.

In general, a cylindrical lens provides optical power along the meridian that is orthogonal to both its longitudinal axis and its optical axis. That meridian does not have to be at 90° or 180°. In FIG. 1C, for example, the cylinder lens 100c is a plano-convex cylinder oriented with its longitudinal axis along the 45° meridian. Its principal meridians have powers of +4.00 D (135°) and 0 D (0°). It has optical power of +2.00 D along the 90° and 180° meridians. This variation in optical power with meridian angle can be represented as F=F_{cyl}(sin(Î)², where F_{cyl} is the cylinder power and Î is the angle between the cylinder axis and the new meridian. FIG. 1D shows the cylinder lens 100b of FIG. 1B annotated with optical powers at meridians of 30°, 45°, 60°, and 90° (representing 25%, 50%, 75%, and 100% of the cylinder power, respectively).

FIG. 1E shows the optical cross for a toric lens that provides −2.00 D of spherical power and +4.00 D of cylinder power along the 45° meridian. The toric lens's optical power along any meridian is the sum of its spherical power and its cylinder power along that meridian. Its major meridians are 45° (+2.00 D) and 135° (−2.00 D). It provides no optical power along the 90° and 180° meridians (Plano).

### SUMMARY

Electroactive (EA) lenses, for example, liquid crystal lenses, can produce many different optical wave front shapes, making them ideal candidates for correcting human vision refractive errors. Although EA lenses can create cylindrical optical power, they are not widely used to correct astigmatism (which is a cylinder power refractive error) in humans because the rotational orientation of the astigmatism error varies, and it has not yet been practical to vary the rotational orientation of cylinder EA lenses without using moving mechanical parts.

The present technology allows an EA lens to produce cylinder power at a variety of different axes without moving parts. This type of EA lens includes many EA lens elements arranged in optical series. Some of these EA lens elements are called cylinder EA lens elements or cylinder lens elements and have linear electrodes that are orthogonal to the optical axis of the EA lens and rotated about the optical axis with respect to the linear electrodes of the other cylinder EA lens elements in the EA lens. The direction or orientation of the linear electrodes in each of these cylinder EA lens elements defines the axis of the cylinder produced by that cylinder EA lens element. One or more other EA lens elements in the EA lens provide spherical correction. This allows the EA lens to adequately correct the sphere, cylinder, and axis in just about any eyeglass or contact lens prescription.

An example electro-active lens may comprise three electro-active elements in optical series with each other. The first electro-active lens element provides a first variable cylinder power in a first meridian of the electro-active lens. The second electro-active lens element provides a second variable cylinder power in a second meridian of the electro-active lens different than the first meridian. And the third electro-active lens element provides a third variable cylinder power in a third meridian of the electro-active lens different than the first and second meridians. The second meridian may be rotated about an optical axis of the electro-active lens with respect to the first meridian by an angle of up to about 24°. Similarly, the third meridian may be rotated about the optical axis of the electro-active lens with respect to the first meridian by an angle of less than 90°.

The first electro-active lens element can include a first liquid crystal layer and a first array of linear electrodes perpendicular to the first meridian and to an optical axis of the electro-active lens and configured to actuate the first liquid crystal layer. Likewise, the second electro-active lens element can include a second liquid crystal layer and a second array of linear electrodes perpendicular to the second meridian and to the optical axis of the electro-active lens and configured to actuate the second liquid crystal layer. And the third electro-active lens element can include a third liquid crystal layer and a third array of linear electrodes perpendicular to the third meridian and to the optical axis of the electro-active lens and configured to actuate the third liquid crystal layer.

The electro-active lens may also include a fourth electro-active lens element in optical series with the first, second, and third electro-active lens elements. In operation, the fourth electro-active lens element provides a fourth variable cylinder power in a fourth meridian of the electro-active lens different than the first, second, and third meridians.

An alternative electro-active lens may include cylindrical electro-active lens elements arranged in optical series with each other and with at least one other electro-active lens element. The cylindrical electro-active lens elements can provide cylindrical optical power at different respective axes with respect to an optical axis of the electro-active lens. And the other electro-active element can provide variable spherical optical power, which may be selected to offset spherical power provided by two or more of the cylindrical electro-active lens elements.

The cylindrical electro-active lens elements may comprise respective layers of bistable electro-active material. There may be three, four, five, or six cylindrical electro-active lens elements. If there are six cylindrical electro-active lens elements, these cylindrical electro-active lens elements can be aligned to provide cylinder power at meridians of 0, 24, 72, 120, 144, and 168 degrees, respectively. Each cylindrical electro-active lens element can be actuated independently.

Each cylindrical electro-active lens element may include a layer of liquid crystal material and an array of linear electrodes. The linear electrodes are in electrical communication with the layer of liquid crystal material and perpendicular to an optical axis of the electro-active lens. They can apply an electric field to the layer of liquid crystal material, thereby causing the layer of liquid crystal material to provide variable cylindrical optical power orthogonal to the optical axis of the electro-active lens.

Cylinder rotational control can be implemented as follows with an electro-active lens comprising a stack of cylindrical electro-active lens elements configured to provide cylindrical optical power at different respective axes with respect to an optical axis of the electro-active lens. The process includes providing cylinder power along a first meridian with a first cylindrical electro-active lens element in the stack of cylindrical electro-active lens elements. While providing cylinder power along the first meridian with the first cylindrical electro-active lens element, a second cylindrical electro-active lens element in the stack of cylindrical electro-active lens elements provides cylinder power along a second meridian within 60 degrees of the first meridian.

The first meridian can be within 24 degrees of the second meridian. The cylinder powers along the first and second meridians can add to produce cylinder power along a meridian halfway between the first and second meridians. The meridian halfway between the first and second meridians can be within 6 degrees of a cylinder correction for a person looking through the electro-active lens.

While providing cylinder power along the first and second meridians with the first and second cylindrical electro-active lens elements, respectively, a third cylindrical electro-active lens element in the stack of cylindrical electro-active lens elements can provide cylinder power along a third meridian different than the first and second meridians. Similarly, one or more lens elements in optical series with the stack of cylindrical electro-active lens elements can provide spherical optical power. This spherical optical power can be selected based on spherical optical power produced in combination by the first and second cylindrical electro-active lens elements.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1A illustrates a vertically oriented cylinder lens superimposed on the corresponding optical cross.

FIG. 1B illustrates a horizontally oriented cylinder lens superimposed on the corresponding optical cross.

FIG. 1C illustrates a diagonally oriented cylinder lens superimposed on the corresponding optical cross.

FIG. 1D illustrates a diagonally oriented cylinder lens superimposed on the corresponding optical cross.

FIG. 1E illustrates an optical cross for a toric lens.

FIG. 2A shows a cylinder electro-active lens element (top) and a plano-concave cylinder lens (bottom).

FIG. 2B shows a cylinder electro-active lens element of FIG. 2A rotated about the optical axis by about 45°.

FIG. 3A shows an electro-active lens that includes a set of rotated cylinder electro-active lens elements arranged in optical series with each other and with a spherical cylinder electro-active lens element.

FIG. 3B shows optical crosses for the third cylinder electro-active element of the electro-active lens of FIG. 3A (left), the fourth cylinder electro-active element (center), and both cylinder electro-active elements together (right).

FIG. 3C is a plot of the optical power as a function of meridian angle for the third cylinder electro-active element of the electro-active lens of FIG. 3A, fourth cylinder electro-active element, both cylinder electro-active elements together, and both cylinder electro-active elements together with spherical power removed or offset.

FIG. 4 is a plot of the Logarithm of the Minimum Angle of Resolution (LogMAR) as measured on a vision chart versus cylinder axis misalignment for four different cylinder powers.

FIG. 5 shows different possible meridian angles for stacked cylinder electro-active lens elements (layers) in an electro-active lens.

FIG. 6 is a plot of 22 different cylinder axes possibilities when utilizing a combination of three cylinder lenses from an available selection of six cylinder lenses.

FIG. 7 is a plot of cylinder axis in degrees versus population for a cohort of 4000 Americans with astigmatism.

FIG. 8 shows an electro-active spectacle lens with stacked cylinder electro-active lens elements for cylinder rotation control.

FIG. 9 shows an electro-active contact with stacked cylinder electro-active lens elements for cylinder rotation control.

FIG. 10 shows an electro-active contact with stacked cylinder electro-active lens elements for cylinder rotation control.

### DETAILED DESCRIPTION

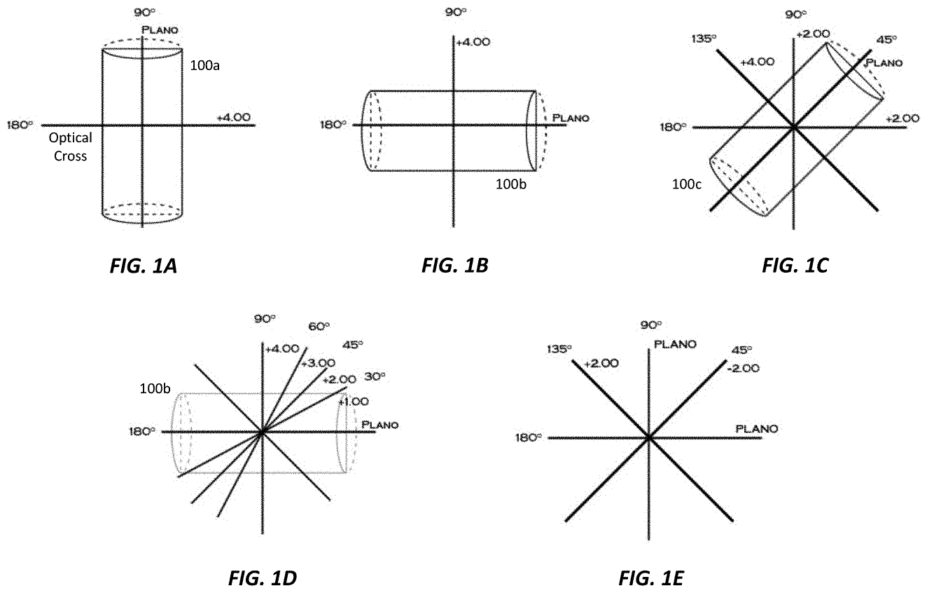

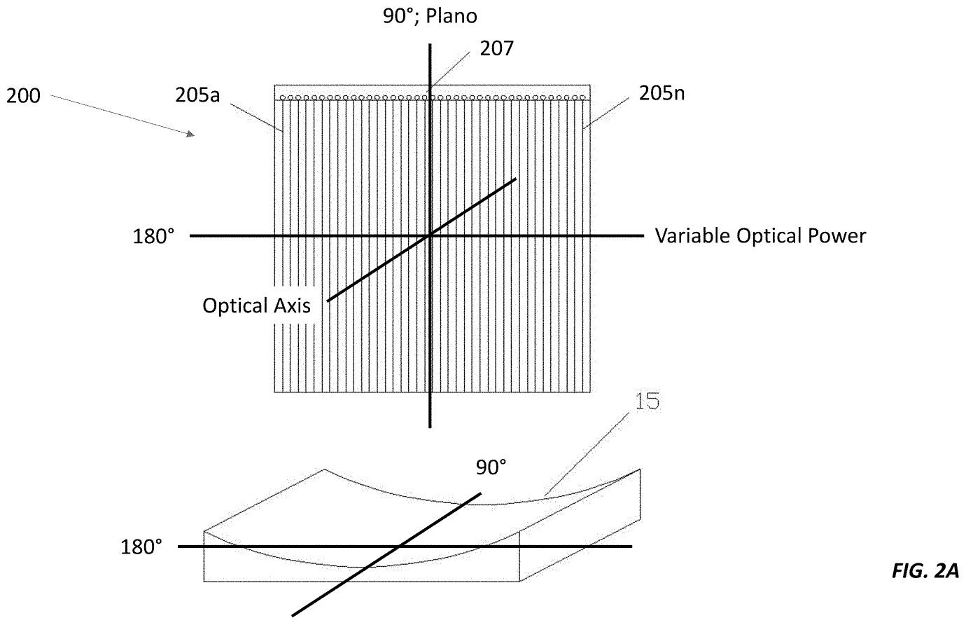

FIGS. 2A and 2B show an example electroactive cylinder lens element 200, also called a cylindrical or cylinder electro-active lens element, that can be used to provide variable cylinder optical power. This electroactive cylinder lens element 200 includes a single layer of electro-active material, such as bistable liquid crystal material, that is sandwiched between a pair of transparent substrates (e.g., made of glass or polymer). One substrate is coated with a ground plane electrode, and the other substrate is coated with an array of parallel linear electrodes 205a-205n. Alignment layers (not shown) on the layers of electrodes 205 may align the liquid crystal material with respect to the substrates and electrodes when no voltage is applied to the electrodes 205. The leftmost electrode 205a and rightmost electrode 205n in this array of parallel linear electrodes are labeled in FIG. 1.

The linear electrodes 205 are coupled to and controlled by an electrode control circuit 207, which can be located at one edge of the electro-active cylinder lens element 200. There could be one electrode control circuit 207 for each electrode 205, or there could be electrodes 205 that share electrode control circuits 207. In the case of shared circuits, there should be at least enough control circuits 207 to produce cylinder optical power.

In operation, the electrode control circuit 207 applies voltages to some or all of the linear electrodes 205. These voltages actuate the electro-active material, changing the optical power of the lens along the 180° meridian, i.e., in a direction orthogonal to the electrodes 205 and to the lens's optical axis, which is normal to the planes of the substrates and electro-active material. The electrode control circuit 207 can apply a different voltage to each electrode 205 in order to produce a cylindrical optical power that mimics the optical power of a conventional plano-concave cylinder lens 15. Plotting the voltage versus electrode number yields a parabolic or circular arc or a phase-wrapped arc mimicking the shape of the concave side of the plano-concave cylinder lens 15. For example, the center electrode could have zero volts applied to it, the immediately adjacent electrodes on both sides of the center electrode could have 0.5 volts applied to them, the next electrodes adjacent to them have a slightly higher voltage, with this pattern of increasing voltage to the electrodes as their distance from the center electrode increases, repeats many times.

Varying the shape and amplitude of this voltage profile changes the cylinder optical power provided by the lens element 200 along the 180° meridian. Typically, the cylinder lens is tunable to deliver a variable amount of cylinder power that can range from 0 to ±6.00 D or more. The lens element 200 provides no optical power along the 90° meridian. If desired, the lens element 200 can be rotated to provide cylinder optic power along another meridian. In FIG. 2B, for example, the lens element 200 is rotated by 45° to provide variable optical power along the 135° meridian and no optical power along the 45° meridian.

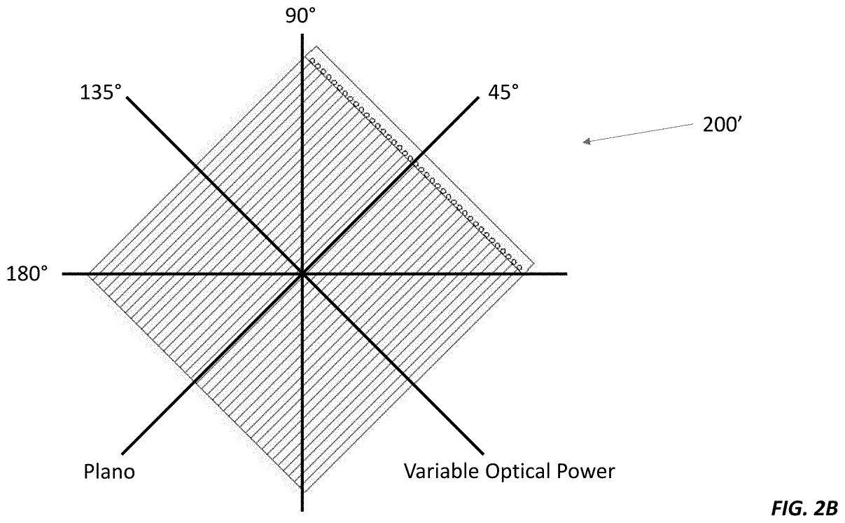

FIG. 3A shows an electro-active lens 300 with several cylinder electro-active lens elements 200a-200d arranged in optical series with a separate spherical electro-active lens element 310 with concentric circular electrodes 315. In this example, there are four cylinder electro-active lens elements 200, but other electro-active lenses 300 may have more or fewer cylinder electro-active lens elements 200 as discussed in greater detail below. Similarly, the electro-active lens 300 may include more or fewer (i.e., zero) spherical electro-active lens elements, each of which can provide the same amount of spherical optical power or different amounts of spherical optical power. Two orthogonally oriented cylinder electro-active lens elements can also be used to provide spherical optical power instead of or in addition to a spherical electro-active lens element with concentric circular electrodes.

The electro-active lens elements can be embedded in or at least partially encapsulated by a transparent substrate. This substrate can be rigid or flexible and may have a refractive index that is the same or substantially the same as the refractive index of the unactuated electro-active (e.g., liquid crystal material) in the lens elements for fail-safe operation. The substrate may have planar outer surfaces that provide no optical power or curved or diffractive outer surfaces or a refractive index gradient to provide a fixed optical power in addition the variable cylindrical and spherical optical power provided by the electro-active lens elements.

In FIG. 3A, the cylinder electro-active lens elements 200a-200d are rotated about the optical axes with respect to each other. That is, the cylinder electro-active lens elements 200a-200d have different principal meridians. The linear electrodes 205 of each cylinder electro-active lens elements 200 is aligned with the corresponding meridian of least optical power. In this example, lens element 200a, 200b, 200c, and 200d are rotated about the optical axis so that their linear electrodes are parallel to the 135°, 15°, 105°, and 45° meridians and provide variable optical power along the orthogonal meridians (i.e., the 135°, 15°, 105°, and 45° meridians, respectively).

One or more control circuits 207 apply electric power to each electrode in the different cylinder electro-active lens elements 200 as explained above. The cylinder electro-active lens elements can be actuated independently of each other, with more than one lens element actuated at the same time. If multiple lens elements are actuated simultaneously, their optical powers add as described above.

For instance, actuating the spherical electro-active lens element 310 and one of the cylindrical electro-active lens elements 200 yields toric optical power for astigmatism correction, e.g., as shown for a conventional toric lens prescription in FIG. 1E. Unlike in a conventional lens, however, the amount of optical power can be adjusted by changing the voltages applied to the electro-active lens elements. In addition, the cylinder power can be rotated about the optical axis (i.e., to different principal meridians) without any moving parts by changing which cylindrical electro-active lens element 200 is actuated. In the electro-active lens 300 in FIG. 3A, the cylindrical electro-active lens elements 200 are aligned along four different axes, making it possible to correct astigmatism along each of these axes by actuating the corresponding cylindrical electro-active lens element 200. Actuating orthogonally aligned cylindrical electro-active lens elements 200 (e.g., cylindrical electro-active lens elements 200b and 200c) to provide the same cylindrical power produces a net spherical power.

If more than one cylindrical electro-active lens element 200 is actuated at the same time, their cylinder powers add, causing the electro-active lens 300 to act as a compound lens. Because the cylindrical electro-active lens elements 200 having different principal meridians (i.e., they are rotated with respect to each other about the optical axis), the principal meridians of the electro-active lens may be at intermediate locations. For example, actuating two cylindrical electro-active lens elements 200 simultaneously yields the greatest optical power along a meridian halfway between the meridians of greatest optical power for the actuated two cylindrical electro-active lens elements 200.

More concretely, actuating cylindrical electro-active lens elements 200c and 200d (with 105° and 45° meridians of greatest optical power, respectively) to provide the same magnitude of cylinder power yields a net or combined greatest cylinder power along the 75° meridian. Similarly, actuating cylindrical electro-active lens elements 200b and 200c (with 15° and 105° meridians of greatest optical power, respectively) to provide the same magnitude of cylinder power yields a net or combined greatest optical power along the 60° meridian. And actuating orthogonal cylindrical electro-active lens elements (e.g., elements 200a and 200d) to provide the same magnitude of cylinder power yields a net spherical power.

FIGS. 3B and 3C and TABLE 1 (below) illustrate the individual and net optical power provided by actuating cylindrical electro-active lens elements 200c and 200d to each provide +4.00 D of cylinder power. FIG. 3B shows optical crosses for element 200c (left), element 200d (middle), and both elements in series (right). The maximum optical power of both elements in series is +6.00 D at a meridian of 75°, which is halfway between the 105° and 45° maximum optical power meridians of elements 200c and 200d, respectively. The minimum optical power of both elements in series is +2.00 D at a meridian of 165°. FIG. 3C and TABLE 1 show the optical powers provided at other meridians.

Actuated together, the two cylindrical electro-active elements 200c and 200d are equivalent to a spherical lens element that provides +2.00 D of optical power in series with a cylinder lens element that provides +4.00 D of cylinder power at an axis of 75°. If desired, the spherical optical power can be offset by actuating the spherical electro-active lens element 310 to provide a spherical power of −2.00 D. With the two cylindrical electro-active elements 200c and 200d actuated to provide maximum cylinder powers of +4.00 D each and the spherical electro-active lens element 310 to provide a spherical power of −2.00 D, the electro-active lens 300 provides a net optical power of +4.00 D of cylinder power at an axis of 75°. Alternatively, the spherical electro-active lens element 310c can be actuated to provide additional spherical power or to reduce the spherical power

TABLE 1

| Meridian (°) | Element 200c | Element 200d | Sum | Less Sphere |
|---|---|---|---|---|
| 0 | 0.27 | 2.00 | 2.27 | 0.27 |
| 15 | 0.00 | 3.00 | 3.00 | 1.00 |
| 30 | 0.27 | 3.73 | 4.00 | 2.00 |
| 45 | 1.00 | 4.00 | 5.00 | 3.00 |
| 60 | 2.00 | 3.73 | 5.73 | 3.73 |
| 75 | 3.00 | 3.00 | 6.00 | 4.00 |
| 90 | 3.73 | 2.00 | 5.73 | 3.73 |
| 105 | 4.00 | 1.00 | 5.00 | 3.00 |
| 120 | 3.73 | 0.27 | 4.00 | 2.00 |
| 135 | 3.00 | 0.00 | 3.00 | 1.00 |
| 150 | 2.00 | 0.27 | 2.27 | 0.27 |
| 165 | 1.00 | 1.00 | 2.00 | 0.00 |
| 180 | 0.27 | 2.00 | 2.27 | 0.27 |

Thus, actuating more than one cylindrical electro-active lens element 200 at the same time makes it possible rotate the net cylinder power provided by the electro-active lens 300 about the optical axis of the electro-active lens 300. The cylindrical electro-active lens elements 200 can be actuated dynamically to provide net cylinder power whose magnitude and rotation angle vary with time. At the same time, the spherical lens element 310 can be actuated dynamically to provide additional spherical power as desired. This spherical power can add to the net power provided by the electro-active lens or reduce any spherical power produced by the actuated cylindrical electro-active lens elements 200.

If the cylindrical electro-active lens elements 200 are bistable, they can also be actuated or set once, then left in that setting to provide a static or constant net cylinder power without consuming any power. For instance, if the cylindrical electro-active lens elements 200 comprise bistable liquid crystal material, applying suitable voltages to the liquid crystal material causes the liquid crystal material to reorient itself and to stay in the reoriented position until subsequent voltages are applied. This liquid crystal reorientation changes the refractive index profiles and hence the cylinder powers provided by the cylindrical electro-active lens elements 200. Alternatively, the cylindrical electro-active lens elements 200 may include electro-active material, such as liquid crystals in a curable polymer matrix, that can be fixed permanently in position by curing with heat or ultraviolet radiation. Fixing the cylindrical power can be very useful for ophthalmic lenses because astigmatic correction is generally the same for both near and far vision correction, which can be corrected dynamically by turning the spherical electro-active lens element 310 on and off.

If the cylindrical electro-active lens elements 200 are set to provide a static cylinder power, they may also provide a static spherical power as in the example of FIGS. 3B and 3C. This static spherical power can be considered a bias spherical power than can add to the static optical power provided by an optional base lens element made of glass or plastic (not shown in FIG. 3A). It can also be offset by switching the spherical electro-active lens element 310 between non-zero values (e.g., between positive and negative values or between two different positive or negative values). For instance, suppose a person's prescription is +0.50 D of cylinder power for both near and far vision and switches between 0.00 D of spherical power for far vision and +1.50 D of spherical power for near vision. If the cylinder electro-active lens elements provide +0.50 D of cylinder power and +0.125 D of spherical power, then the spherical electro-active lens element can be set to provide −0.125 D of spherical power when off and +1.375 D of spherical power when on for net spherical powers of 0.00 D and +1.50 D when off and on, respectively.

### Number and Alignment of Cylindrical Electro-Active Lens Elements

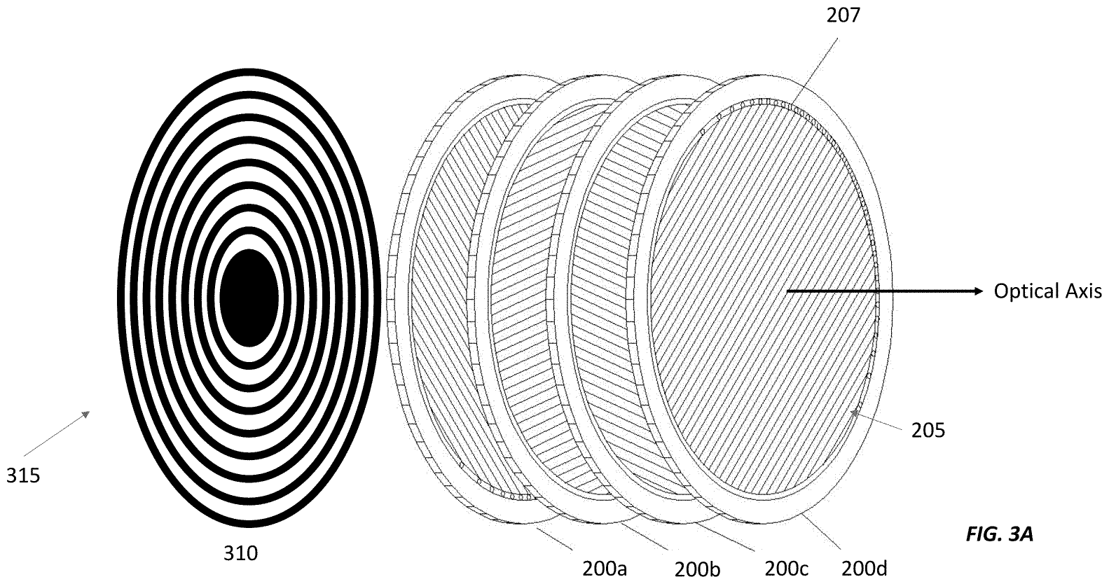

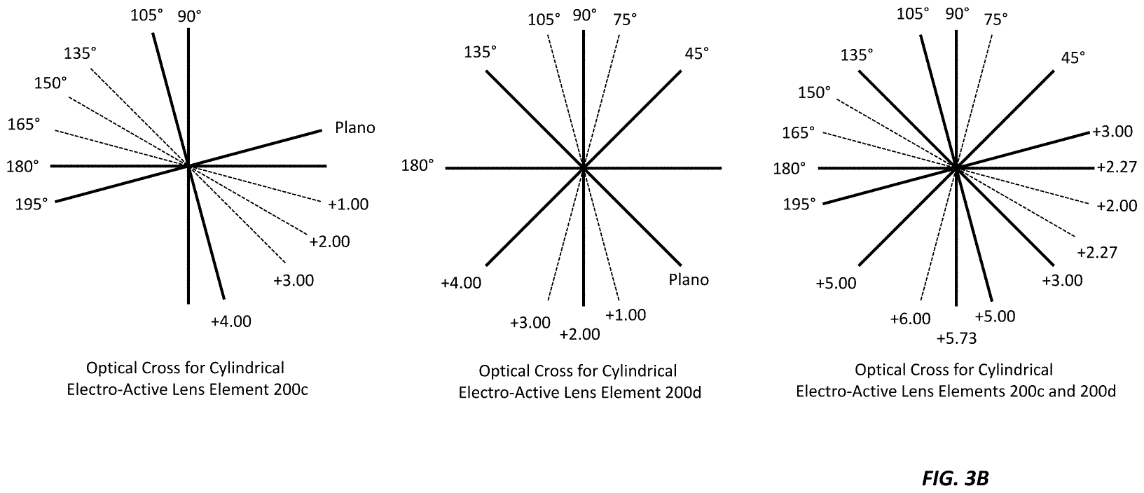

The number and alignment of cylindrical electro-active lens elements in an electro-active lens with cylinder rotational control depend on the desired degree of cylinder rotational control. For ophthalmic applications, clinical studies show that if the cylinder axis correction is aligned to within ±6° of the actual axis of the desired cylinder prescription, the visual outcome is satisfactory. FIG. 4, for example, is a plot of the Logarithm of the Minimum Angle of Resolution (LogMAR) as measured on a vision chart versus cylinder axis misalignment for four different cylinder powers: full cylinder power (solid black line), under correction by 0.25 diopters cyl (DC; solid dark gray line), under correction by 0.5 DC (dashed light gray line), and under correction by 0.75 DC (dotted line). It shows that the LogMAR varies by less than 0.1 from the best corrected visual acuity (BCVA), even for full correction, for cylinder axis misalignments of up to about ±10°. At cylinder axis misalignments of up to about ±5°, the LogMAR varies by less than 0.05 from BCVA. This suggests that the rotational control of the cylinder's axis for the corrective lenses does not need to be continuously adjustable—it can be incrementally adjusted in rotational steps that are within 20°, 12°, 10°, 6°, or less of each other.

As mentioned above with respect to FIG. 3A, one way of providing multiple axes of cylinder rotation in an electro-active lens is to stack several cylinder electro-active lens elements, each with a different axis of rotation (principal meridians). Then, when a particular axis of rotation is desired, the cylinder electro-active lens element with that axis of rotation is switched on, and the other cylinder electro-active lens elements are switched off. For example, a lens with 15 layers can provide adjustment in 6° increments or steps.

FIG. 4 shows fifteen increments of axis rotation for aligning cylinder lens correction provided by cylindrical electro-active lens elements to within 6° of the desired axis correction. These increments/meridians are 0, 12, 24, 36, 48, 60, 72, 84, 96, 108, 120, 132, 144, 156, 168 and 180 degrees. An electro-active lens with fifteen cylindrical electro-active lens elements aligned to provide cylinder power at these meridians can correct a person's astigmatism as follows. The axis of astigmatism in the eye ranges from zero to 180°. If there are fifteen cylindrical electro-active lens elements arrayed at evenly spaced meridians as in FIG. 4, the increment between the meridians of adjacent cylindrical electro-active lens elements is 12°. Any desired axis rotation should fall within 6° of the meridian of greatest optical power of one of these cylindrical electro-active lens elements. For example, if the desired axis correction is 30°, that axis value lies halfway between—and 6° apart from—the cylinder power provided by the two cylindrical electro-active lens elements that can provide cylinder power along the 24° and 36° meridians. Either of these cylindrical electro-active lens elements could therefore provide adequate correction. In another example, a desired axis correction at a meridian of 31° is 5° from the cylindrical electro-active lens element aligned with the 36° meridian. The axis (meridian) of the cylinder can be held stationary when used in spectacle lens by the spectacle frames, by the capsule when used in IOLs, and by a weight placed in the bottom of a contact lens.

Although stacking fifteen layers (cylindrical electro-active lens elements) in a single electro-active lens is possible, there are drawbacks to having so many layers of liquid crystal material. Some of those drawbacks are greater complexity, greater thickness, and greater haze when looking through the electro-active lens. It can be desirable to reduce the number of layers used, while still providing a large number of possible cylindrical correction axes.

Fortunately, an electro-active lens can produce fifteen different cylinder rotations using fewer than fifteen layers (cylindrical electro-active lens elements) by actuating more than one layer at a time. For example, if the layer that produces cylinder power along the 48° meridian is switched on in combination with the layer that produces cylinder power at the 24° meridian, then a resulting axis of rotation would be (halfway) between those values at 36°. Utilizing this approach, the number of layers can be reduced from 15 to 9, e.g., aligned with meridians of 0, 24, 48, 72, 96, 120, 144, 168 and 180 degrees (here, 180 degrees is divided into nine increments of 24 degrees, including the starting and ending values).

TABLE 2 (below) shows the resulting axes produced when adjacent electrodes are switched on, producing fifteen combinations of axes utilizing only eight layers of cylindrical electro-active lens elements. The columns headed “Axis 1” and “Axis 2” indicate the rotational orientations (meridians) of the first and second actuated cylindrical electro-active lens elements. Each actuated cylindrical electro-active lens element provides the same amount of cylinder power in this example. Blanks in the “Axis 2” column indicate that only one cylindrical electro-active lens element is actuated. The column headed “Result” lists the rotational axis (meridian) with the greatest net cylinder power for the actuated cylindrical electro-active lens element(s).

TABLE 2

| Axis 1 | Axis 2 | Result |
|---|---|---|
| 0 | | 0 |
| 0 | 24 | 12 |
| 24 | | 24 |
| 24 | 48 | 36 |
| 48 | | 48 |
| 48 | 72 | 60 |
| 72 | | 72 |
| 72 | 96 | 84 |
| 96 | | 96 |
| 96 | 130 | 108 |
| 130 | | 120 |
| 130 | 154 | 132 |
| 154 | | 144 |
| 154 | 180 | 156 |
| 180 | | 168 |

The first and last layers are redundant (the 0° and 180° meridians are coincident), so one of them can be eliminated, leaving eight stacked layers (cylindrical electro-active lens elements). Even with just eight stacked layers, the electro-active lens can still provide astigmatism correction aligned to within 6°. This is accomplished by utilizing the zero-degree axis in place of the 180-degree axis, which are optically equivalent. Therefore, for example, a correction at meridian of 174° is equidistant between the 0° and 168° meridians (with 0° coincident with 180°), within 6 degrees of each. This reduces the number of angular increments to 14, which can be achieved with 8 layers, e.g., 0, 24, 48, 72, 96, 120, 144, and 168 degrees.

An even smaller number of layers can be utilized to achieve 14 increments by activating two different layers that are not necessarily adjacent to each other. For example, TABLE 3 shows that an electro-active lens with six layers (cylindrical electro-active elements) at meridians of 0, 24, 72, 120, 144, and 168 degrees can produce 15 different cylinder rotations in 12° increments.

TABLE 3

| Axis 1 | Axis 2 | Result |
|---|---|---|
| 0 | none | 0 |
| 0 | 24 | 12 |
| 24 | none | 24 |
| 0 | 72 | 36 |
| 24 | 72 | 48 |
| 0 | 120 | 60 |
| 72 | none | 72 |
| 24 | 144 | 84 |
| 24 | 168 | 96 |
| 72 | 144 | 108 |
| 120 | none | 120 |
| 120 | 144 | 132 |
| 168 | 120 | 144 |
| 168 | 144 | 156 |
| 168 | none | 168 |

An even finer level of resolution can be achieved actuating three layers simultaneously rather than just two. TABLE 4, for example, shows the cylinder rotation meridians achievable by stacking six cylindrical electro-active lens elements aligned with meridians of 0, 24, 72, 120, 144, and 168 degrees. Actuating three of these lens elements at a time yields twenty-two possible unique cylinder axis rotations can be made, with finer resolution in the central distribution. (Unique cylinder axis rotations are shown sorted at right in TABLE 4.)

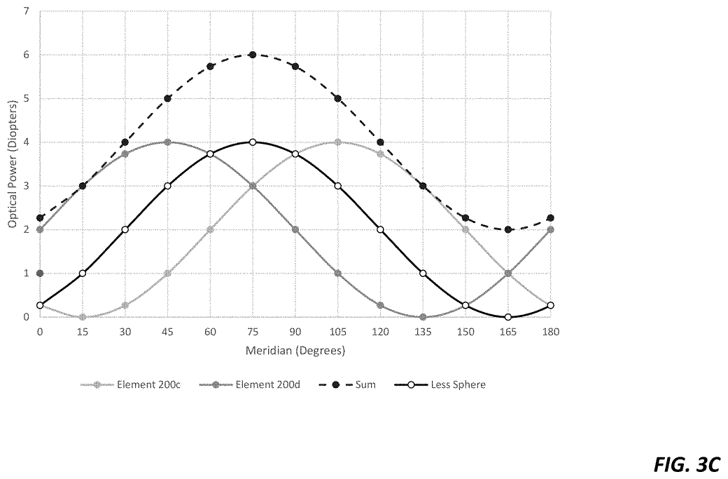

FIG. 6 is a plot of 22 different cylinder axes possibilities when selecting and turning on only three lenses from an assortment of the six differently oriented lenses as described above with respect to TABLES 3 and 4.

TABLE 4

| Axis 1 | Axis 2 | Axis 3 | Result | result, sorted |
|---|---|---|---|---|
| 0 | | | 0 | 0 |
| 24 | | | 24 | 12 |
| 72 | | | 72 | 24 |
| 120 | | | 120 | 32 |
| 144 | | | 144 | 36 |
| 168 | | | 168 | 48 |
| 0 | 24 | | 12 | 56 |
| 0 | 72 | | 36 | 60 |
| 0 | 120 | | 60 | 64 |
| 0 | 144 | | 72 | 72 |
| 0 | 168 | | 84 | 80 |
| 0 | 24 | 72 | 32 | 84 |
| 0 | 24 | 120 | 48 | 88 |
| 0 | 24 | 144 | 56 | 96 |
| 0 | 24 | 168 | 64 | 104 |
| 0 | 72 | 120 | 64 | 108 |
| 0 | 72 | 144 | 72 | 112 |
| 0 | 72 | 168 | 80 | 120 |
| 0 | 120 | 144 | 88 | 132 |
| 0 | 120 | 168 | 96 | 144 |
| 0 | 144 | 168 | 104 | 156 |
| 24 | 72 | | 48 | 168 |
| 24 | 120 | | 72 | |
| 24 | 144 | | 84 | |
| 24 | 168 | | 96 | |
| 24 | 72 | 120 | 72 | |
| 24 | 72 | 144 | 80 | |
| 24 | 72 | 168 | 88 | |
| 24 | 120 | 144 | 96 | |
| 24 | 120 | 168 | 104 | |
| 24 | 144 | | 84 | |
| 24 | 144 | 168 | 112 | |
| 72 | 120 | | 96 | |
| 72 | 144 | | 108 | |
| 72 | 168 | | 120 | |
| 72 | 120 | 144 | 112 | |
| 72 | 120 | 168 | 120 | |
| 120 | 144 | | 132 | |
| 120 | 144 | 168 | 144 | |
| 144 | 168 | | 156 | |

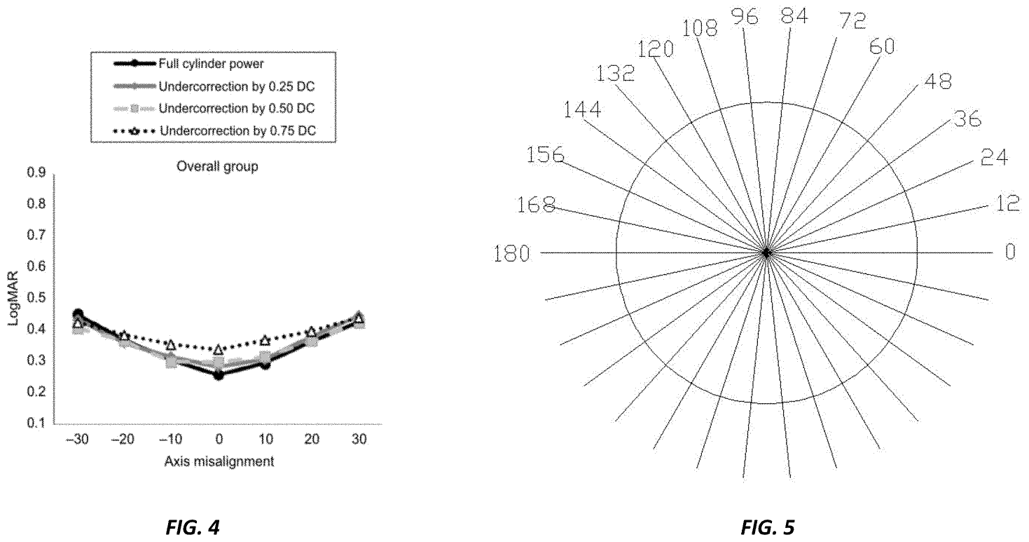

FIG. 7 is a plot of the distribution of cylinder meridians in a US population cohort of 4,000 people with astigmatism. The vertical axis shows the cylinder axis, and the horizontal axis shows the population count. It shows that cylinder axis is not evenly distributed: instead, about half the cohort (2000 people) have cylinder axes between about 80° and 100°. The other 2000 or so people in the cohort have cylinder axes that fall between 0 and 80° or between 100° and 180°. This distribution suggests that it is possible to provide cylinder correction for a large portion of the astigmatic population with an electro-active lens with fewer than six stacked layers (cylinder electro-active lens elements). Or the layers of an electro-active lens could be rotated to provide finer resolution (i.e., correction within less than 6° of the desired cylinder axis) between 80° and 100°.

For instance, an electro-active lens with fewer layers could produce some but not all of the desired increments to meet the cylinder axis possibilities for every patient. For example, an electro-active lens with four layers can produce fourteen unique cylinder axis combinations, but these combinations might not span 180 degrees in 12-degree steps. However, such a lens could be configured as Stock Keeping Unit (SKU) #1 and used for patients whose cylinder axis falls with the range of 0° through 84°, while a second SKU #2 with four layers at different meridians could be configured for patients whose cylinder falls within the range of 96° through 180°. A disadvantage of this approach is that two SKUs would be needed, but an advantage is that each SKU would have only four layers rather than six and could be simpler, thinner, lighter, and clearer (i.e., less hazy). Such an approach could be taken further to increase the number of SKUs to further decrease the number of layers per SKU as desired.

TABLES 5 and 6 (below) show possible design parameters for SKU #1 and SKU #2. Each SKU has four layers (cylinder electro-active lens elements) A—D oriented to provide cylinder power along different axes (meridians). Actuating one, two, or three layers in each SKU produces net cylinder power spanning the desired range. These parameters can be adjusted as desired. The layers can be set or fixed once according to the patient's prescription as described above. The SKUs may also include static or dynamic spherical lens elements to provide additional spherical power or offset spherical power provided by the layers.

TABLE 5

| | SKU #1, 0 thru 84 degrees | | |
|---|---|---|---|
| A | 0 | degrees | |
| B | 24 | degrees | |
| C | 60 | degrees | |
| D | 84 | degrees | |
| Layer 1 | Layer 2 | Layer 3 | Result |
| 0 | | | 0 |
| 0 | 24 | | 12 |
| 0 | 24 | 60 | 28 |
| 0 | 24 | 84 | 36 |
| 0 | 60 | | 30 |
| 0 | 60 | 84 | 48 |
| 0 | 84 | | 42 |
| 24 | | | 24 |
| 24 | 60 | | 42 |
| 24 | 60 | 84 | 56 |
| 24 | 84 | | 54 |
| 60 | | | 60 |
| 60 | 84 | | 72 |
| 84 | | | 84 |

TABLE 6

| | SKU #2, 96 thru 180 degrees | | |
|---|---|---|---|
| A | 96 | degrees | |
| B | 120 | degrees | |
| C | 156 | degrees | |
| D | 180 | degrees | |
| Layer 1 | Layer 2 | Layer 3 | Result |
| 96 | | | 96 |
| 96 | 120 | | 108 |
| 96 | 120 | 156 | 124 |
| 96 | 120 | 180 | 132 |
| 96 | 156 | | 126 |
| 96 | 156 | 180 | 144 |
| 96 | 180 | | 138 |
| 120 | | | 120 |
| 120 | 156 | | 138 |
| 120 | 156 | 180 | 152 |
| 120 | 180 | | 150 |
| 156 | | | 156 |
| 156 | 180 | | 168 |
| 180 | | | 180 |

The examples above illustrate the concept and are not intended to be a comprehensive listing of all possible combinations, which are quite numerous. Those of ordinary skill in the art can calculate other combinations that could include fewer or more layers and finer or coarser increments of axis separations, or even a series of axes that do not encompass the entire 180 degrees and instead are clustered into a narrower group to achieve a finer level of resolution within that group.

Spectacles, Contact Lenses, and Intraocular Lenses with Cylinder Rotational Control

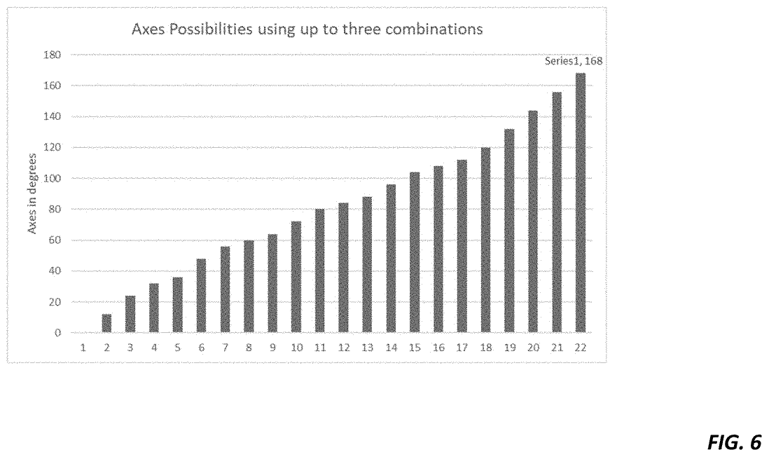

FIG. 8 shows spectacles or eyewear 800 with electro-active lenses 810 with cylinder rotational control. The electro-active lenses 810 are held in place by a frame front 820, which is connected to left and right temples 830 via respective (optional) hinges. Together, the frame front 820, temples 830, and optional hinges form the frames of the eyewear 800. There are at least three and possibly more stacked cylinder electro-active lens elements (layers) 812 embedded in each lens 810. These layers 812 are actuated by linear electrodes, similar to the electro-active lens 300 shown in FIG. 3A. Each lens 810 may also include a dynamic spherical lens element stacked with the layers 812. And the lens 810 itself may have curved outer surfaces to provide additional sphere or cylinder power.

The cylinder electro-active layers 812 in each lens 810 are rotated with respect to each other about the lens's optical axis to provide rotational control of adjustable/dynamic cylinder correction provided by the lenses 810 as explained above. The lenses 810 may provide this rotational control in response to sensor readings or user input via a switch on the eyewear 800 or remote control (e.g., a smart phone with a suitable app) wirelessly coupled to the electronics 814. Or the rotational control can be fixed, e.g., by an optometrist who determines the patient's prescription and fits the glasses to the patient.

In this case, each set of electro-active layers 812 is sealed or formed within a glass or plastic base lens element, e.g., using 3D printing or other additive manufacturing techniques. The base lens element can provide a fixed optical power of −30 Diopters to +30 Diopters. For certain applications, such as augmented or virtual reality applications, the base lens element may not provide any optical power (i.e., it may have an optical power of 0 Diopters).

The electro-active layers 812 are powered and controlled by electronics 814, which may be embedded in the periphery of the base lens element, out of the wearer's line of sight, as shown in FIG. 8. Some or all of these electronics may also be embedded or contained in the frame front 820 or the temples 830, with wired or wireless electrical connections between the electronics and power supply. These electrical connections may take the form of conductive traces or wires that run through or across the (optional) hinges and the base lens element. They can also take the form of conductive loops that wirelessly couple energy from the power supply to the layers 812 and/or electronics 814.

Because the electro-active layers 812 provide cylinder rotational control, the lenses 810 can be fitted to the frame front 820 without regard to their alignment. This makes it easier to shape the lenses 810, either with edging techniques or 3D printing techniques, and to align the lenses 810 to the frame front 820—unless the base lens element provides a fixed rotational power or correction, rotational alignment of the lens 810 with respect to the frame front 820 is not necessary. Instead, the lenses 810 can be inserted into the frame front 820 with any rotational orientation, and the cylindrical power can be adjusted (once or repeatedly, if desired) by actuating the layers 812 with the control electronics 814.

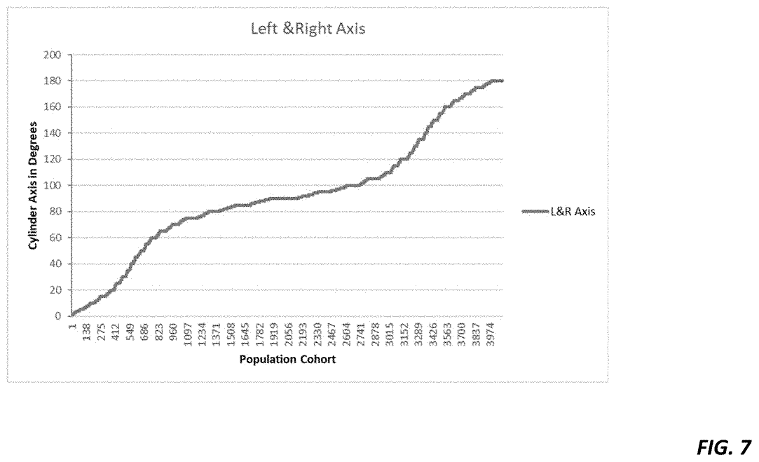

FIG. 9 shows an electro-active contact lens 900 that provides cylinder rotational control. Like the spectacle lenses 810 in FIG. 8, the electro-active contact lens 900 includes stacked electro-active layers 912 embedded in or affixed to a base optical element 910. Each electro-active layer 912 has its own parallel linear electrodes rotated at a different angle with respect to the contact lens's optical axis and provides cylinder power along a different meridian (e.g., like the stacked electro-active layers 200 in FIG. 3A). The base optical element 910 can provide a fixed optical power that ranges from −30 Diopters to +30 Diopters (including 0 Diopters) and is made of biocompatible material, such as soft, permeable acrylic or other material suitable for use in a contact lens. The base optical element 910 also encapsulates electronics 914 and a power supply, such as a capacitor or battery, that powers the electronics 914 and the layers 912. The electronics 914 and power supply can be made of transparent or translucent materials and/or disposed out of the user's line of sight.

The electronics 914 may include a sensor that detects or measures the contact lens's rotational orientation with respect to the desired cylinder rotational angle. The electronics 914 use this information to actuate the layers 914 to provide the desired cylindrical power. Alternatively, or in addition, the electronics 914 may include an antenna or other wireless interface, in which case the electronics 914 may actuate the layers 914 in response to wireless commands from a remote control operated by the wearer or an optometrist.

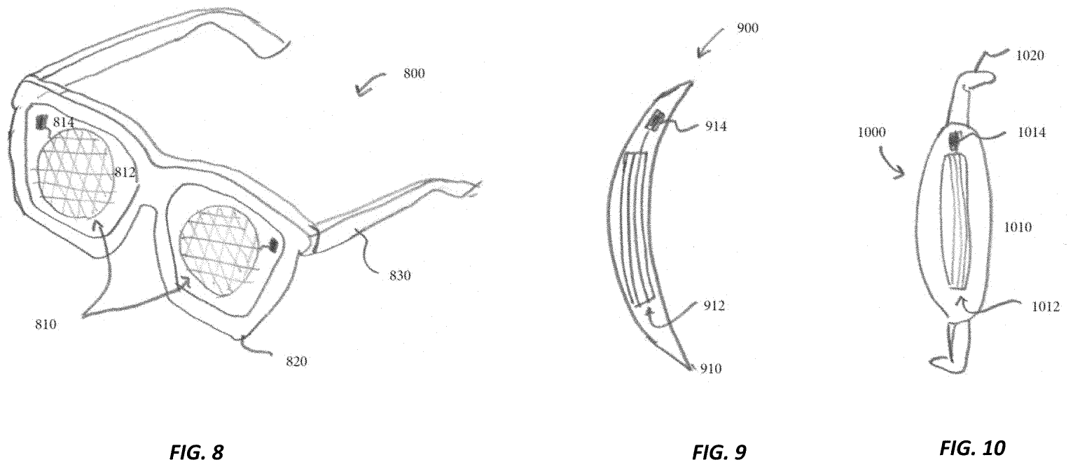

FIG. 10 shows an electro-active intraocular lens (IOL) 1000 with cylinder rotational control. The electro-active IOL 1000 includes haptics 1020 that extend from a base lens element 1010 that hermetically encapsulates both stacked, rotated electro-active layers 1012 with linear electrodes, electronics 1014, and a power supply, similar to the electro-active contact lens 900 in FIG. 9. The base lens element 1010 may also provide a fixed optical power from −30 Diopters to +30 Diopters. The IOL 1000 may be flexible so that it can curled or folded, then inserted into the eye via a small incision. Once inside the eye, the IOL 1000 unfurls, and the haptics 1020 anchor the IOL 1000 in place. Unfortunately, the rotational orientation of the anchored IOL 1000 may not match the desired rotational axis. Fortunately, the electronics 1014 can actuate the EA layers 1012 to provide any of a range of cylindrical corrections as described above in order to compensate for this misalignment. The exact cylindrical correction can be set by the patient or surgeon via remote control or using a sensor inside or coupled to the IOL 800 that measures the patient's astigmatism.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electro-active lens comprising:
a first electro-active lens element configured to provide a first variable cylinder power in a first meridian of the electro-active lens;
a second electro-active lens element in optical series with the first electro-active lens element and configured to provide a second variable cylinder power in a second meridian of the electro-active lens different than the first meridian; and
a third electro-active lens element in optical series with the first electro-active lens element and the second electro-active lens element and configured to provide a third variable cylinder power in a third meridian of the electro-active lens different than the first meridian and the second meridian.

2. The electro-active lens of claim 1, wherein the second meridian is rotated about an optical axis of the electro-active lens with respect to the first meridian by an angle of up to about 24°.

3. The electro-active lens of claim 1, wherein the third meridian is rotated about an optical axis of the electro-active lens with respect to the first meridian by an angle of less than 90°.

4. The electro-active lens of claim 1, wherein:
the first electro-active lens element includes a first liquid crystal layer and a first array of linear electrodes perpendicular to the first meridian and to an optical axis of the electro-active lens and configured to actuate the first liquid crystal layer,
the second electro-active lens element includes a second liquid crystal layer and a second array of linear electrodes perpendicular to the second meridian and to the optical axis of the electro-active lens and configured to actuate the second liquid crystal layer, and
the third electro-active lens element includes a third liquid crystal layer and a third array of linear electrodes perpendicular to the third meridian and to the optical axis of the electro-active lens and configured to actuate the third liquid crystal layer.

5. The electro-active lens of claim 1, further comprising:
a fourth electro-active lens element in optical series with the first electro-active lens element, the second electro-active lens element, and the third electro-active lens element and configured to provide a fourth variable cylinder power in a fourth meridian of the electro-active lens different than the first meridian, the second meridian, and the third meridian.

6. An electro-active lens comprising:
cylindrical electro-active lens elements arranged in optical series with each other and configured to provide cylindrical optical power at different respective axes with respect to an optical axis of the electro-active lens; and
at least one electro-active element arranged in optical series with the cylindrical electro-active lens elements and configured to provide variable spherical optical power.

7. The electro-active lens of claim 6, wherein the cylindrical electro-active lens elements comprise respective layers of bistable electro-active material.

8. The electro-active lens of claim 6, wherein the cylindrical electro-active lens elements comprise three cylindrical electro-active lens elements.

9. The electro-active lens of claim 6, wherein the cylindrical electro-active lens elements comprise four cylindrical electro-active lens elements.

10. The electro-active lens of claim 6, wherein the cylindrical electro-active lens elements comprise five cylindrical electro-active lens elements.

11. The electro-active lens of claim 6, wherein the cylindrical electro-active lens elements comprise six cylindrical electro-active lens elements.

12. The electro-active lens of claim 11, wherein the six cylindrical electro-active lens elements are aligned to provide cylinder power at meridians of 0, 24, 72, 120, 144, and 168 degrees, respectively.

13. The electro-active lens of claim 6, wherein each of the cylindrical electro-active lens elements is configured to be actuated independently.

14. The electro-active lens of claim 6, wherein each of the cylindrical electro-active lens elements comprises:
a layer of liquid crystal material; and
an array of linear electrodes, in electrical communication with the layer of liquid crystal material and perpendicular to an optical axis of the electro-active lens, configured to apply an electric field to the layer of liquid crystal material, thereby causing the layer of liquid crystal material to provide variable cylindrical optical power orthogonal to the optical axis of the electro-active lens.

15. The electro-active lens of claim 6, wherein the at least one electro-active element is configured to provide the variable spherical optical power that offsets spherical power provided by two or more of the cylindrical electro-active lens elements.

16. A method of operating an electro-active lens comprising a stack of cylindrical electro-active lens elements and configured to provide cylindrical optical power at different respective axes with respect to an optical axis of the electro-active lens, the method comprising:
providing cylinder power along a first meridian with a first cylindrical electro-active lens element in the stack of cylindrical electro-active lens elements; and
while providing cylinder power along the first meridian with the first cylindrical electro-active lens element, providing cylinder power along a second meridian within 60 degrees of the first meridian with a second cylindrical electro-active lens element in the stack of cylindrical electro-active lens elements.

17. The method of claim 16, wherein the first meridian is within 24 degrees of the second meridian.

18. The method of claim 16, wherein the cylinder power along the first meridian and the cylinder power along the second meridian add to produce cylinder power along a meridian halfway between the first meridian and the second meridian.

19. The method of claim 18, wherein the meridian halfway between the first meridian and the second meridian is within 6 degrees of a cylinder correction for a person looking through the electro-active lens.

20. The method of claim 16, further comprising:
while providing cylinder power along the first meridian with the first cylindrical electro-active lens element and cylinder power along the second meridian with the second cylindrical electro-active lens element, providing cylinder power along a third meridian different than the first meridian and the second meridian with a third cylindrical electro-active lens element in the stack of cylindrical electro-active lens elements.

21. The method of claim 16, further comprising:
while providing cylinder power along the first meridian with the first cylindrical electro-active lens element and cylinder power along the second meridian with the second cylindrical electro-active lens element, providing spherical optical power with at least one lens element in optical series with the stack of cylindrical electro-active lens elements.

22. The method of claim 21, further comprising:
selecting the spherical optical power provided by the at least one lens element based on spherical optical power produced in combination by the first cylindrical electro-active lens element and the second cylindrical electro-active lens element.
